(19) United States
(12) Patent Application Publication
(10) Pub. No.: US 2006/0241994 A1
(43) Pub. Date: Oct. 26, 2006

(54) Automated support for monitoring and managing knowledge work

(76) Inventors: Kumar Anand, Hyderabad (IN); Nori Kesav Vithal, Hyderabad (IN); Mandaleeka Guru Prasada Lakshmi Narayana, Hyderabad (IN)

Correspondence Address: HEDMAN & COSTIGAN P.C., 1185 AVENUE OF THE AMERICAS, NEW YORK, NY, 10036, US

(21) Appl. No.: 11/405,101

(22) Filed: Apr. 17, 2006

(30) Foreign Application Priority Data
Apr. 20, 2005 (IN) 492/MUM/2005

(51) Int. Cl. G06F 9/46

(52) U.S. Cl. 705/8

(57) ABSTRACT

A system for activity tracking of a project on a network is disclosed. The system comprising means for configuring desk and non desk based activities and applications. The system further comprises means for tracking and monitoring the configured activities and application depending on the priority assigned to each configured activity and application. The system is provided with means for storing the monitored activities and generating a report of the activities monitored.

### FIELD OF INVENTION

This invention relates to an activity tracking system. In particular, this invention relates to an activity tracking system on a computer network.

### BACKGROUND OF INVENTION

### DEFINITIONS

As used in this specification the following words are generally intended to have a meaning as set forth below, except to the extent that the context in which they are used indicate otherwise.

‘Project’ means a temporary endeavor undertaken to create a unique product or service by following a pre determined plan.

‘Network means a collection of terminals, computers, servers, and components which allows for the easy flow of data and use of resources between one another.

‘Activity’ means any task undertaken as a part of the steps related to the completion of a project.

‘Desk Based Activity’ means any task performed on a terminal or computer, which is a part of the network.

‘Application’ means a computer program used for conducting an activity.

### INTRODUCTION

The essence of project control is to accomplish assigned tasks in time, within a budget while meeting the agreed upon quality. Monitoring the time required for completion of a particular task is important. The time estimates are based on time taken to complete similar or same tasks. Thus measurement of time while providing to monitor current task will also serve as basis for current billing and future estimates. The accuracy of these measurements is of paramount importance, both from the point of view of logging the time taken and provides a basis for future plan.

Steps involved in the process of project control and project management are as follows:
(i) setting out the objectives, completion time and costing of the project;
(ii) assigning activities to each team member by the project supervisor;
(iii) manually tracking the activity of each team member when organizing team meetings; client meetings; project discussions and
(iv) Manually generating weekly or monthly reports at the end of every team meeting.

In the prior art the aforementioned activities are done manually. A team member has to manually login and logout. There is a possibility that a team member might forget to logout in such a case the system known in the prior art will continue to monitor thus leading to erroneous reading of time spent for a particular activity. Each team member has to manually make an entry of the activities being performed and the applications used while performing the activity, also the time spent in each of these activities and applications have to be manually entered. In such a case it is possible for a team member to provide misleading and wrong information, which leads to generation of erroneous reports related to the activities being performed. The system known in the prior art does not provide a means for authenticating the data provided by each of the team members either. The generation of inaccurate results leads to faulty estimation of the time required for the completion of any task related to the project, thereby increasing the overall time required for completion of the project, consequently increasing the cost incurred for completion of the project.

The system known in the prior art does not provide the facility of configuring the activities related to the project. It does not provide the facility to allocate time for each activity being performed. Using a system known in the prior art time spent on non desk based activities related to the project such as meeting and discussions cannot be tracked. The system does not provide the facility of tracking activities of a single user working on multiple projects.

Hence there is a need for automated tracking of the activities related to project control and project management.

Another object of this invention is to provide a system for identifying the activities that need to be tracked for a project.

Another object of this invention is to provide a system for automatically tracking the activities performed on every computer in a computer network for a project.

Another object of this invention is to provide a system for tracking the time spent by each team member on a particular application for a project.

Another object of this invention is to provide a system for generation of log timesheet entries based on the activities tracked for a project.

Another object of this invention is to provide a system for automatic generation of weekly and monthly reports on the basis of the activites tracked for a project.

Another object of this invention is to provide a system for manual reconfiguration of unallocated time to activities tracked for a project.

### SUMMARY OF THE INVENTION

In accordance with this invention there is provides an activity tracking system for tracking various activities related to a project, said activity tracking system comprising:
(i) an activity configuration component adapted to configure desk based activites related to said project;
(ii) an application configuration component adapted to configure applications related to each of said activities;
(iii) a scheduling component adapted to configure non desk based activities relating to said project;
(iv) a mapping component adapted to receive inputs from said activity configuration component, application configuration component and scheduling component and further adapted to map said activities and applications received onto a map;
(v) a classifying component adapted to classify said mapped activites and applications into groups;
(vi) an integrating component adapted to receive said classified group;
(vii) a tracking component adapted to receive said classified groups and track each of said activities and applications within said classified group;
(viii) a reconfiguring component adapted to track unallocated time on unknown activities logged;
(ix) a prioritizing component adapted to prioritize said classified groups and activities within said classified groups;
(x) a conflict resolving component adapted to resolve conflict in priority between two or more activities or two or more groups;
(xi) at least one monitoring component adapted to receive inputs from said tracking component, prioritizing component and conflict resolving component and further adapted to monitor the time spent for a particular activity and in a particular application and generating a result; and
(xii) a database component adapted to receive said results from each of said monitoring components for storage and reporting.

Typically, said database component comprises a reporting component adapted to receive information stored in said database component, said reporting component adapted to generate detailed daily and weekly reports. Typically, said monitoring component comprises;
(i) a file monitoring component adapted to monitor time spent in working on a particular file in a particular application for a particular activity in a particular group;
(ii) a folder monitoring component adapted to monitor time spent in working on a folder in a particular application in a particular activity in a particular group;
(iii) a web page monitoring component adapted to monitor the time spent in accessing any web page for a particular activity;
(iv) an application monitoring component adapted to monitor the time spent in a particular application.

Typically, the reporting component has a computational component adapted to compute the total time spent on various activities using various applications within different classified groups.

### BRIEF DESCRIPTION OF THE ACCOMPANYING DRAWINGS

The invention will be described in detail with reference to a preferred embodiment. Reference to this embodiment does not limit the scope of the invention.

In the accompanying drawings:

FIG. 1 illustrates a block schematic of the activity tracking system in accordance with this invention.

### DETAILED DESCRIPTION OF THE ACCOMPANYING DRAWING

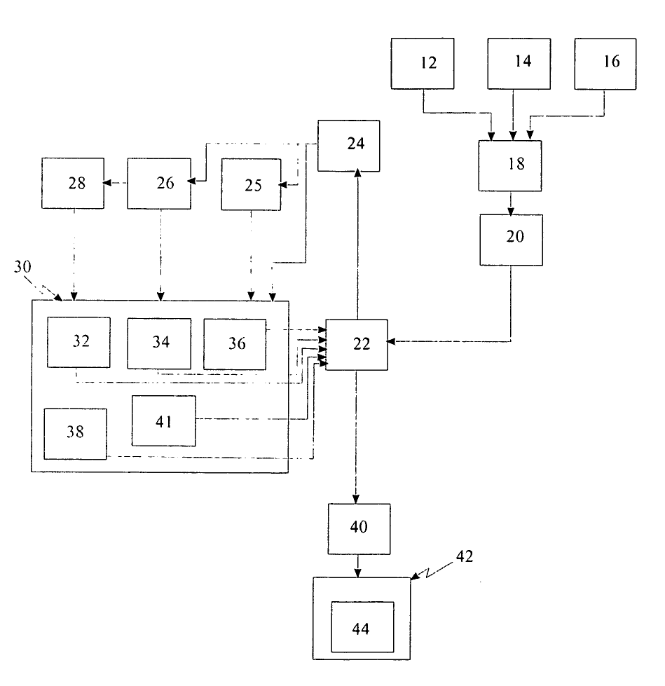

The invention will now be explained with reference to FIG. 1 of the accompanying drawings.

FIG. 1 illustrates a block schematic of the activity tracking system in accordance with this invention. The activity tracking system comprises:
(i) activity configuration component (12);
(ii) application configuration component (14);
(iii) scheduling component (16);
(iv) mapping component (18);
(v) classifying component (20);
(vi) integrating component (22);
(vii) tracking component (24);
(viii) reconfiguring component (25)
(ix) prioritizing component (26);
(x) conflict resolving component (28);
(xi) monitoring component (30);
   a. file monitoring component (32);
   b. folder monitoring component (34);
   c. web page monitoring component (36);
   d. application monitoring component (38);
(xii) database component (40);
(xiii) reporting component (42); and
(xiv) computational component (44).

An activity configuration component (12) facilitates configuration of the activities, typically desk based activities that need to be tracked. An application configuration component (14) is provided for configuring the applications to be tracked in relation to the activity being performed. A scheduling component (16) is also provided to schedule activities typically, non desk based activites. A mapping component (18) is provided for mapping the activities desk based or non desk based and the application together. The mapping component receives input from the activity configuration component (12), the application configuration component (14) and the scheduling component (16). A classifying component (20) is provided for classifying the activities, which are mapped into groups of related activites. The activities thus classified are given as input to an integrating component (22).

The integrating component (22) then provides the list of classified activities to a tracking component (24). The tracking component (24) tracks the application and the activity related to that application. A reconfiguring component (25) is also provided to track unallocated time on unknown activities logged. A prioritizing component (26) is provided for the purpose of prioritizing which activity and application should be tracked in which sequence. Consequently a conflict resolving component (28) is provided which help resolve conflict in event of two or more activities of same priority being active at one point in time. The outputs of the tracking component (24), prioritizing component (26) and conflict resolving component (28) is provided to a monitoring component (30) which facilitates monitoring of the activities and applications.

The monitoring component (30) comprises:
(i) a file monitoring component (32), which monitors the time spent in working on a particular file in a particular application for a particular activity.
(ii) a folder monitoring component (34), which monitors the time spent in working on a folder in a particular application in a particular activity in a particular group.
(iii) a web page monitoring component (36), which monitors the time spent in accessing any web page for a particular activity.
(iv) an application monitoring component (38), which monitors the time spent on a particular application.

The outputs of the monitoring components (32), (34), (36) and (38) are given to a database component (40) which facilitates storage of all the activities monitored by the monitoring components (32), (34), (36) and (38). The monitoring component (30) is in the form of a server computer, which may be hardwired, Bluetooth based wireless connection or a LAN based connection in case the monitoring is done within a single office premises. In case of the monitoring is done for an organization having branch offices in different cities the monitoring component (30) would be a internet based monitoring component which monitors the activities from time to time. The monitoring component (30) is thus a parallel network. A supervisory component (41), which is a part of the monitoring component, supervises and the activities and the applications being used and the time spent on each of the activities and the applications.

In case a particular team member is working on three different projects at the same time. The activity tracking system provides the facility of a password controlled entry and exit from the activities related to the project. This enables the monitoring component (30) to monitor the time spent in the activities and applications related to a particular project. When the team member enter the username and password the supervisory component (41) is activated and the system starts monitoring the activities and applications configured for a particular project only. In case a team member is working on a single project at a time the monitoring component (30) is continuously logged on and the supervisory component continuously monitors the configured activities and applications.

The monitored information stored in the database is provided to a reporting component (42) via the integrating component (22). The reporting component (42) prepares a detailed report of the activities tracked and monitored on every workstation in the network. The reporting component (42) has a computational component (44) which computes the time spent by every team member while performing a particular activity using a particular application.

While considerable emphasis has been placed herein on the various components of the preferred embodiment, it will be appreciated that many alterations can be made and that many modifications can be made in the preferred embodiment without departing from the principles of the invention. These and other changes in the preferred embodiment as well as other embodiments of the invention will be apparent to those skilled in the art from the disclosure herein, whereby it is to be distinctly understood that the foregoing descriptive matter is to be interpreted merely as illustrative of the invention and not as a limitation.

We claim:

1. A system for activity tracking of a project on a network, said system comprising:
(i) an activity configuration component adapted to configure desk based activites related to said project;
(ii) an application configuration component adapted to configure applications related to each of said activities;
(iii) a scheduling component adapted to configure non desk based activities relating to said project;
(iv) a mapping component adapted to receive inputs from said activity configuration component, application configuration component and scheduling component and further adapted to map said activities and applications received onto a map;
(v) a classifying component adapted to classify said mapped activites and applications into groups;
(vi) an integrating component adapted to receive said classified group;
(vii) a tracking component adapted to receive said classified groups and track each of said activities and applications within said classified group;
(viii) a reconfiguring component adapted to track unallocated time on unknown activities logged;
(ix) a prioritizing component adapted to prioritize said classified groups and activities within said classified groups;
(x) a conflict resolving component adapted to resolve conflict in priority between two or more activities or two or more groups;
(xi) at least one monitoring component adapted to receive inputs from said tracking component, prioritizing component and conflict resolving component and further adapted to monitor the time spent for a particular activity and in a particular application and generating a result; and
(xii) a database component adapted to receive said results from each of said monitoring components for storage and reporting.

2. A system for activity tracking as claimed in claim 1, wherein said database component comprises a reporting component adapted to receive information stored in said database component, said reporting component adapted to generate detailed daily and weekly reports.

3. A system for activity tracking as claimed in claim 1, wherein said monitoring component comprises;
(i) a file monitoring component adapted to monitor time spent in working on a particular file in a particular application for a particular activity in a particular group;
(ii) a folder monitoring component adapted to monitor time spent in working on a folder in a particular application in a particular activity in a particular group;
(iii) a web page monitoring component adapted to monitor the time spent in accessing any web page for a particular activity;
(iv) an application monitoring component adapted to monitor the time spent in a particular application.

4. A system for activity tracking as claimed in claim 1, wherein said reporting component comprises a computational component adapted to compute time spent in performing all the activities and applications.

5. A system for activity tracking as claimed in claim 1, as herein described with reference to the accompanying drawings.
